(19) United States
(12) Patent Application Publication
(10) Pub. No.: US 2004/0179032 A1
(43) Pub. Date: Sep. 16, 2004

(54) Method of intelligent video stream modification

(75) Inventor: Ho-Chao Huang, Taipei (TW)

Correspondence Address: QUINTERO LAW OFFICE, 1617 BROADWAY, 3RD FLOOR, SANTA MONICA, CA, 90404, US

(73) Assignee: CyberLink Corp.

(21) Appl. No.: 10/661,754

(22) Filed: Sep. 12, 2003

(30) Foreign Application Priority Data
Mar. 14, 2003 (TW) 92105581

(51) Int. Cl. G09G 5/00

(52) U.S. Cl. 345/723

(57) ABSTRACT

A method for intelligent video stream modification. A digital video stream is segmented into at least one video partition, and multiple frames are acquired therefrom. The modification area and the reference area are processed by compression and decompression algorithms to output a final edited digital video stream.

### BACKGROUND OF THE INVENTION

1. Field of the Invention

The present invention relates to a video stream modification method, and more particularly, to a method of modifying frames of video groups in a video stream.

2. Description of the Related Art

Video process has become increasingly convenient with advancement of digital video technology. Digital video cameras capture motion and sound, recording to a digital video stream of AVI, MPEG, or other formats. Digital video editing software removes unwanted footage, adds titles, subtitles, sound, or special effects to complete a digital video stream. In order to decrease file size, the stream is compressed by various compression algorithms, such as variable length coding, block-base motion compensation or discrete cosine conversion. Digital video can be stored in such media formats as VCD or DVD in such formats as AVI, MPEG, RAM or others.

Films have been converted to various types of digital video files for better preservation. A film input from conventional video camera, video tape recorder or TV, is converted using sampling, digitization, or other techniques to a digital video stream. Various video editing applications, such as Adobe Premiere, Main Actor, Pinnacle Studio, or others, create the digital video stream, subsequently saved to digital video files.

In order to make high quality digital video, video process software eliminates frame errors, flattens image edges, and corrects colors. Digital video streams are preferably compressed using MPEG format to decrease file size. Each MPEG video stream includes three types of frame, intra-frame (I-frame), predicted-frame (P-frame) and bidirectional-frame (B-frame). I-frame, a fundamental frame, is not coded differentially with respect to other frames. P-frame uses the most recent I-frame or P-frame (subsequent prediction) as the reference for motion-compensated prediction. B-frame is bidirectionally predicted, based on both previous and following frames. Producing B-frame consumes excessive time, usually 1.3 to 3 times the full video length.

Digital video editing software can add special effects into a digital video stream. Conventionally, a digital video stream must be fully decompressed to add insertions, such as title, subtitle, or special effects, and subsequently re-compressed. The conventional modification process entails several limitations often associated with excessive effort in decompression/compression. In addition, the decompression/compression process causes resolution decrease due to the nature of the compression algorithm.

To address the situation described, a new video editing technique, Smart Video Rendering Technology (SVRT), has been introduced. SVRT automatically detects modification frames and reproduces only related frames in a digital video stream to shorten time and maintain video resolution. As well, SVRT directly converts video to MPEG without additional conversion to AVI, saving hard disc space and shortening time.

Although the solution is feasible, several problems remain. In most situations, reproduction of related frames is unnecessary because only a few portions of the frame are modified, such that it is necessary to choose the proper unit to reproduce in video editing. In view of these limitations, a need exists for a method of video stream modification that reproduces only portions of the frame, shortening time spent and maintaining video resolution.

### SUMMARY OF THE INVENTION

It is therefore an object of the present invention to provide a method of intelligent video stream modification that detects edited frames and reproduces only related frames of the digital video, thereby shortening process time and maintaining video resolution.

According to the above object, the method first segments a digital video stream into at least one video partition using a video segmentation unit. A video analysis unit analyzes the video partition to acquire a plurality of frames, selects at least one first frame therefrom, and determines a first modification area of the first frame according to insertions. A frame process unit processes the first modification area according to insertions, and returns the first modification area of the first frame to generate the final edited digital video stream. The method detects modification areas and reproduces the related areas to generate a final edited digital video stream to shorten time and maintain video resolution.

### BRIEF DESCRIPTION OF THE DRAWINGS

The present invention can be more fully understood by reading the subsequent detailed description and examples with references made to the accompanying drawings, wherein:

FIG. 1 is a diagram showing the structure of an MPEG-2 file;

FIG. 2 is a diagram showing the frame architecture of an MPEG-2 file;

FIG. 3 is a diagram of the architecture according to the present invention;

FIG. 4 is a flowchart showing the method of intelligent video stream modification according to the invention.

### DETAILED DESCRIPTION OF THE INVENTION

The invention provides a method of intelligent video stream modification to edit frames in digital video stream.

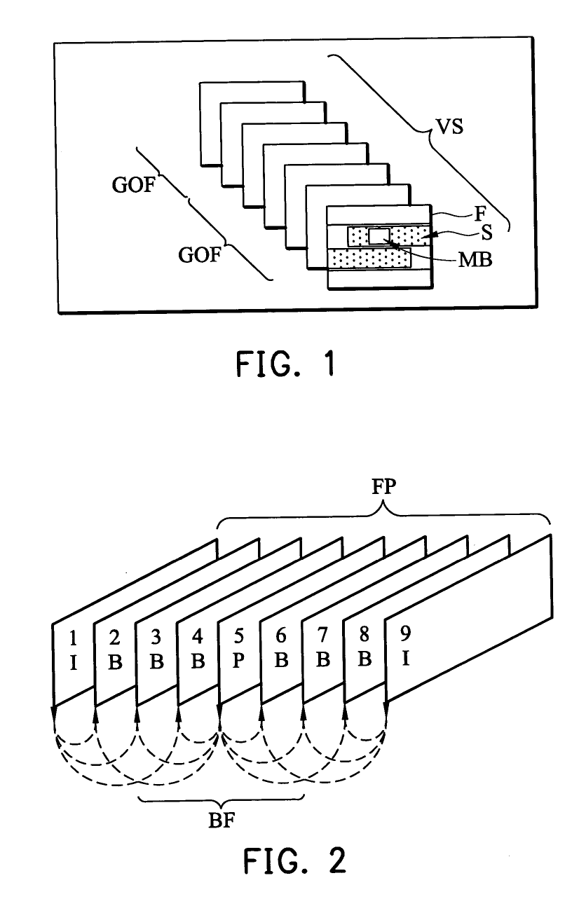

FIG. 1 is a diagram showing the structure of an MPEG-2 file. A video sequence (VS) is composed of multiple frames or groups of frames (GOP). The frame (F), a basic unit in compression, includes three types of frame, intra-coded frame (I-frame), predicted coded frame (P-frame), and bidirectionally predicted frame (B-frame). Each frame is divided horizontally into fixed lengths to produce multiple sections (Ss) as the minimum unit in signal synchronization and error control. Each S is composed of multiple macroblocks (MBs) at 16*16 pixels is the minimum unit in color sampling, motion estimation and motion compensation. Each MB, composed of four blocks of 8*8 pixels is the minimum unit in discrete cosine convert.

FIG. 2 is a diagram showing the frame architecture of an MPEG-2 file. In MPEG-2 file, I-frame has no reference frame, and is compressed by quantization and variable length coding methods, thus, can be treated as an initiation point for decompression without other frames. The I-frame is the first frame in the VS or GOP, and those following are P-frames and B-frames. I-frames thus require protection during file transfer to prevent data loss and further damage to subsequent frames. A P-frame refers to one reference frame, such as an I-frame or prior P-frame, to locate similar MBs. When there are no similar MB, all MBs in the P-frame are compressed using intra-coding. Basically, P-frames are composed of both intra-coded MBs and predicted coded MBs, where the content of the predicted coded MB is a movement vector and calculated according to the reference frame. The compression rate of P-frames is normally higher than that of I-frames because P-frames are compressed by motion prediction methods based on a reference frame. A B-frame refers to both subsequent and previous reference frames to locate similar MBs. Like the P-frame, when there are no similar MB, all MBs in the B-frame use intra-coding for compression. The compression rate of B-frames is normally higher than that of the other two types because B-frames refer to both subsequent and previous frame to increase likelihood of locating similar MBs in compression using motion estimation methods. B-frames cannot be further referenced by other frames.

In order to acquire high compression rate, MPEG adopts multiple methods of compression a digital video stream. First, MBs of frames are capturen as an elementary unit to use block-based motion compensation methods to code I-frames, P-frames and B-frames. After that, discrete cosine conversion methods are used to eliminate space correlations and quantized methods ignore unimportant data in a digital video stream. Finally, variable length coding methods are executed together with dynamic vectors to produce a compressed digital video stream. The following example illustrates the block-based motion compensation methods. In FIG. 2, the GOP includes three types of frames, I, B, and P, I-frame, B-frame and P-frame respectively. Frame 1, the I-frame, has no relationship to other frames. Frame 5, the P-frame, refers to Frame 1 using subsequent prediction methods of compression and the frame 2, the B-frame, not only refers to the previous frame 1 but the subsequent frame 5, and uses interpolation prediction compression methods.

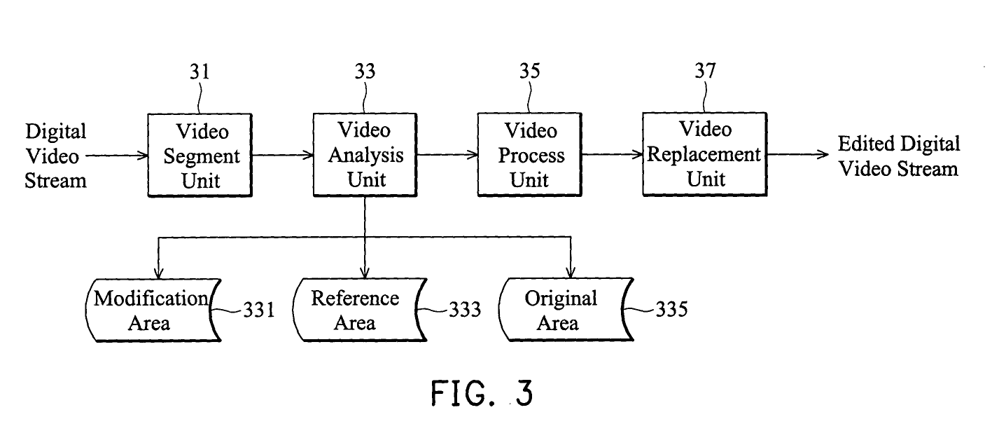

FIG. 3 is a diagram of the architecture according to the present invention. According to the concepts disclosed, the method not only eases digital video editing, but maintains original resolution. Details of the method are further described as follows.

The architecture comprises a video segmentation unit 31, a video analysis unit 33, a video processing unit 35 and a video replacement unit 37. The video segmentation unit 31 segments a digital video stream into at least one video partition comprising multiple frames. The video analysis unit 33 analyzes the video partition to acquire at least one modification frame and determines modification areas 331 therein to add insertions from the modification frames. The video analysis unit 33 detects reference frames according to the modification areas 331 and defines the reference areas 333 therein. The reference areas 333 can be located in the modification frame or other frames. Areas other than the modification area 331 in the modification frame are defined as original areas 335. The video processing unit 35 decompresses the modification area 331 and the reference area 333 using decompression algorithms. The video processing unit 35 adds insertions to the modification area 331 and subsequently updates the associated reference area 333, ignoring original areas 335. Compression algorithms are used to compress both the modification area 331 and reference area 333. The video replacement unit 37 returns the modification area 331, the reference area 333, and the original areas 335 to the video partition to generate the final edited digital video stream.

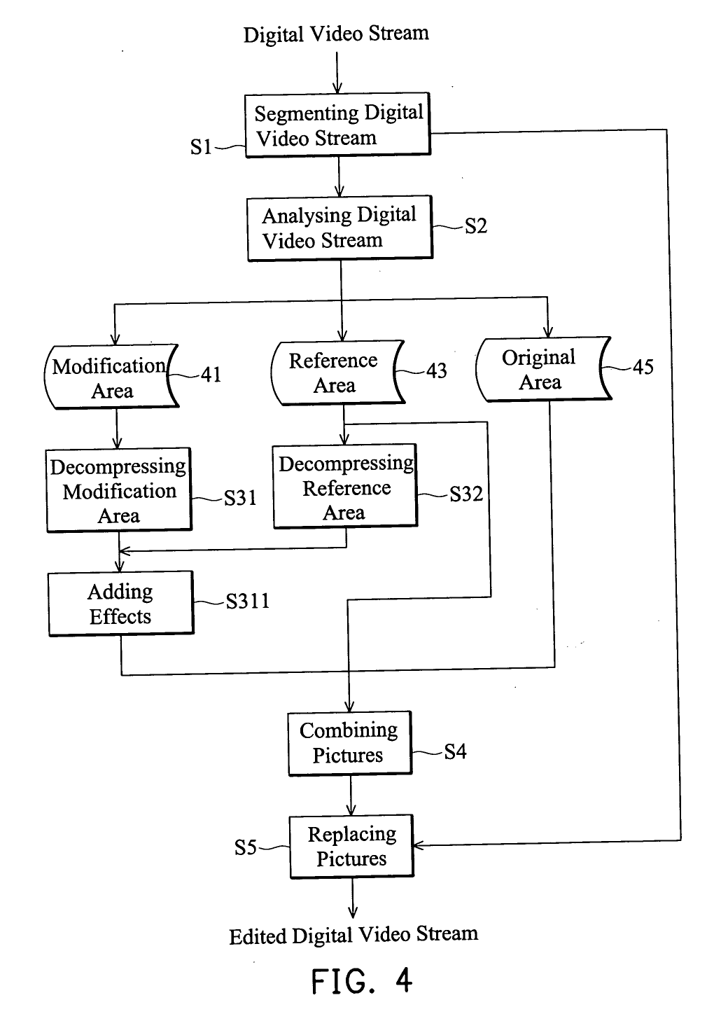

FIG. 4 is a flowchart showing the method of intelligent video stream modification according to the invention. The method comprises the following steps.

First, in step S1, the digital video stream is segmented using a video segmentation unit 31 into at least one video partition containing multiple frames.

In step S2, the video analysis unit 33 acquires at least one modification frame and determines the modification area 41 for insertions. If the modification area 41 has a reference frame, the video analysis unit 33 defines the reference area 43. Frames other than the modification area 331 of the modification frame are defined as original areas 335.

In step S31, the modification area 41 is decompressed by decompression algorithms.

In step S311, insertions are added into the modification area 41, which is subsequently compressed.

In step S32, the reference area 43 of the digital video stream is decompressed by decompression algorithms.

In step S4, a video combination unit is provided to combine the modification area 41, the reference area 43 and the original area 45.

In step S5, the modification area 41, the reference area 43 and the original area 45 are returned to generate the final edited digital video stream.

The method detects modification areas and reproduces the related areas to generate a final edited digital video stream, thereby shortening time while maintaining video resolution.

The method of the present invention, or certain aspects or portions thereof, may capture the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method of modifying a digital video stream according to the at least one insertion, the method comprising using a computer to perform the steps of:
segmenting the digital video stream into at least one video partition;
acquiring a plurality of first frames by analyzing at least one video partition;
determining a first modification area in the first frame for at least one insertion;
modifying the first modification area according to the at least one insertion to acquire a first processed area; and
replacing the first modification area of the first frame with the first processed area and thereby generating a final edited digital video stream.

2. The method as claimed in claim 1 further comprising, in the step of modifying the first modification area, if the first modification area of the first frame refers to at least one second frame, the steps of:
defining at least one second reference area in the second frame according to the first modification area;
modifying the second reference area according to the first modification area to acquire a second processed area; and
replacing the second reference area of the second frame with the second processed area.

3. The method as claimed in claim 1 further comprising, in the step of modifying the first modification area, if the first modification area refers to the first frame, the steps of:
defining at least one first reference area of the first frame according to the first modification area;
modifying the first reference area according to the first modification area to acquire a third processed area; and
replacing the first reference area of the first frame with the third processed area.

4. The method as claimed in claim 2 wherein, in the step of modifying the second reference area, the first modification area and the second reference area are decompressed for modification.

5. The method as claimed in claim 2 further comprising, after modification, compressing the first modification area using a video compression algorithm.

6. A system of modifying a digital video stream according to the at least one insertion, comprising:
a video segmentation unit segmenting the digital video stream into at least one video partition;
a video analysis unit acquiring at least one first frame by analyzing at least one video partition, and determining a first modification area corresponding to the at least one insertion;
a video processing unit modifying the first modification area according to the at least one insertion to acquire a first processed area; and
a video replacement unit replacing the first modification area of the first frame with the first processed area, thereby generating a final edited digital video stream.

7. The system as claimed in claim 6 wherein the video processing unit, if the first modification area of the first frame refers to at least one second frame, defines at least one second reference area of the second frame according to the first modification area, modifies the second reference area according to the first modification area to acquire a second processed area, and replaces the second reference area of the second frame with the second processed area.

8. The system as claimed in claim 6 wherein the video processing unit, if the first modification area of the first frame refers to the first frame, defines at least one first reference area of the first frame according to the first modification area, modifies the first reference area to acquire a third processed area, and replaces the first reference area of the first frame with the third processed area.

9. The system as claimed in claim 7 wherein the first modification area and the second reference area are decompressed for modifying.

10. The system as claimed in claim 7 wherein in the video processing unit, a video compression algorithm is used to compress the first modification area after processing the first modification area.

11. A storage medium for storing a computer program providing a method of modifying a digital video stream according to the at least one insertion, comprising:
segmenting the digital video stream into at least one video partition;
acquiring a plurality of first frames by analyzing at least one video partition;
determining a first modification area in the first frame for the at least one insertion;
modifying the first modification area according to the at least one insertion to acquire a first processed area; and
replacing the first modification area of the first frame with the first processed area and thereby generating a final edited digital video stream.

12. The storage medium as claimed in claim 11, further comprising, in the step of modifying the first modification area, if the first modification area of the first frame refers to at least one second frame, the steps of:
defining at least one second reference area in the second frame according to the first modification area;
modifying the second reference area according to the first modification area to acquire a second processed area; and
replacing the second reference area of the second frame with the second processed area.

13. The storage medium as claimed in claim 11 further comprising, in the step of modifying the first modification area, if the first modification area refers to the first frame, the steps of:
defining at least one first reference area of the first frame according to the first modification area;
modifying the first reference area according to the first modification area to acquire a third processed area; and
replacing the first reference area of the first frame with the third processed area.

14. The storage medium as claimed in claim 12 wherein, in the step of modifying the second reference area, the first modification area and the second reference area are decompressed for modification.

15. The storage medium as claimed in claim 12 further comprising, after modification, compressing the first modification area using a video compression algorithm.
